(19) United States
(12) Patent Application Publication
(10) Pub. No.: US 2025/0087714 A1
(43) Pub. Date: Mar. 13, 2025

(54) UNITIZED FUEL CELL

(71) Applicants: Hyundai Motor Company, Seoul (KR); Kia Corporation, Seoul (KR)

(72) Inventors: Jong Hyeok Noh, Ansan-si (KR); Jin Hyeok Yoo, Yongin-si (KR); Duk Hoon Kwon, Hwaseong-si (KR); Byeong-Heon Jeong, Seoul (KR); Seung Hun Han, Osan-si (KR)

(21) Appl. No.: 18/412,884

(22) Filed: Jan. 15, 2024

(30) Foreign Application Priority Data
Sep. 13, 2023 (KR) 10-2023-0121814

(51) Int. Cl. H01M 8/0258; H01M 8/0206; H01M 8/0267; H01M 8/0273; H01M 8/028; H01M 8/2404; H01M 8/1004

(52) U.S. Cl. CPC H01M 8/0258; H01M 8/0206; H01M 8/0267; H01M 8/0273; H01M 8/028; H01M 8/2404; H01M 8/1004

(57) ABSTRACT

In an embodiment, a unitized fuel cell includes a cell frame, a plurality of separators each including a cooling medium guide part extending from a manifold hole and having a selected area, a plurality of support protrusions protruding from the guide part of each of the separators toward the cooling surface, spaced apart from each other, and including a cooling medium flow field between the spaced protrusions, and an adhesive medium between the cell frame and the reaction surface on the guide part of each of the separators to provide a coupling force to each of the separators and the cell frame. In some embodiments, the adhesive medium does not overlap the plurality of support protrusions on the guide part.

### CROSS-REFERENCE TO RELATED APPLICATIONS

This application claims the benefit of Korean Patent Application No. 10-2023-0121814, filed on Sep. 13, 2023, which application is hereby incorporated herein by reference.

### TECHNICAL FIELD

The present disclosure relates to a unitized fuel cell.

### BACKGROUND

A fuel cell is a kind of power generator that converts chemical energy of fuel into electric energy by electrochemically reacting the fuel in a stack. The fuel cell may not only supply driving power for industries, homes, buildings, aviation, and vehicles, but also be used to supply power of a small electronic product such as a portable device. Recently, the use field of the fuel cell is being gradually expanded as a highly-efficient clean energy source.

A membrane-electrode assembly (MEA) is located at an innermost position of a unit cell of a general fuel cell. The MEA is composed of a polymer electrolyte membrane that may move protons, and an anode and a cathode that are electrodes arranged so that hydrogen and oxygen may react on both sides of the electrolyte membrane.

Further, a gas diffusion layer (GDL) is stacked on the outer portion of the MEA, that is, the outer portion where the anode and the cathode are located. A separator with a flow field is located outside the GDL to supply fuel and discharge water generated by reactions.

By stacking a plurality of unit cells constructed as described above in series to generate a desired level of power from the fuel cell, a fuel cell stack is formed. In a fuel cell stack, an end plate is attached to the outermost unit cell among the unit cells to support and secure the plurality of unit cells.

Conventionally, to maintain the air-tightness of the unit cell and ensure convenience in a stacking process, an Electricity Generating Assembly (EGA) that integrates the MEA and the GDL may be manufactured and used.

Recently, research has been conducted on a cell frame, which integrates the EGA and a frame supporting the EGA.

One of the results of this research is to make an elastic frame surrounding the edge of the EGA.

The elastic frame is made by manufacturing a sheet-shaped frame using heat-sealable thermoplastic elastomer (TPE) and then joining it with the EGA through heat sealing. In this case, the EGA may be damaged or the elastic frame may be deformed due to heat and pressure provided during heat sealing for joining.

Further, because the elastic frame is joined to the separator made of a metal material through heat sealing, a problem occurs in which joining between the separator and the elastic frame is not achieved at a desired level. As a result, when manufacturing the fuel cell stack by stacking the unit cells, the unit cells may not be aligned with each other.

On the other hand, when manufacturing and using this type of EGA, it is possible to reduce the amount of the electrolyte membrane used, thus reducing cost. However, when a stack is manufactured by simply stacking several components, a cell assembly tolerance increases, it is difficult to replace only a cell determined as a defective cell within the stack, and there is a limit to increasing the productivity of the stack.

In addition, there is a need to develop a technology that secures a necessary flow field for the cooling medium while maximizing the area of a reaction region compared to an entire cell area, perfectly performs sealing, and optimizes the flow field, thus increasing cooling efficiency.

The description provided above as a related art of the present disclosure is for helping to understand the background of the present disclosure and should not be construed as necessarily being included in the related art publicly known.

### SUMMARY

The present disclosure relates to a unitized fuel cell that is integrated into one cell unit, thus facilitating assembly and repair and, more particularly, to a unitized fuel cell that has excellent sealing of a cooling medium, is easy to secure a flow field for the cooling medium, and has excellent cooling efficiency due to low deformation of the flow field, thereby effectively preventing the fuel cell from deteriorating.

An embodiment of the present disclosure provides a unitized fuel cell that has excellent sealing of a cooling medium, is easy to secure a flow field for the cooling medium, and has excellent cooling efficiency due to the low deformation of the flow field, thereby effectively preventing the fuel cell from deteriorating.

In an embodiment of the present disclosure, a unitized fuel cell includes a cell frame to which an Electricity Generating Assembly (EGA) and a frame are coupled, a plurality of separators stacked on both sides of the cell frame, respectively, each separator including on a first side thereof a reaction surface to face the cell frame, including on a second side thereof a cooling surface through which a cooling medium flows, including on an end thereof a manifold hole through which the cooling medium flows, and including a cooling medium guide part extending from the manifold hole and having a predetermined area, a plurality of support protrusions protruding from the guide part of each of the separators toward the cooling surface, spaced apart from each other, and including a cooling medium flow field between the spaced protrusions, and an adhesive medium disposed between the cell frame and the reaction surface on the guide part of each of the separators to provide a coupling force to each of the separators and the cell frame, and provided at a point that does not overlap the plurality of support protrusions on the guide part.

The EGA may be configured by coupling an electrolyte membrane, an electrode, and a gas diffusion layer, the frame may be formed of a plastic material, and the EGA and the frame may be integrally coupled to form the cell frame.

The cell frame and each of the separators may be integrally coupled through the adhesive medium, so one pair of separators and the cell frame disposed between the pair of separators may form one unitized unit fuel cell.

One fuel cell and another adjacent fuel cell may be stacked so that the cooling surfaces of the separators face each other, and a gasket may be positioned between the facing separators to seal the cooling medium.

One fuel cell and another adjacent fuel cell may be stacked so that the cooling surfaces of the separators face each other, and the two separators may be mutually supported through the support protrusions in the guide parts.

The two separators facing the cooling surfaces may be formed such that the support protrusions are formed at corresponding points in the guide parts, and thereby the support protrusions of the two separators may be supported while contacting each other at ends thereof.

The two separators facing the cooling surfaces may be formed such that the support protrusions are offset from each other in the guide parts, and thereby an end of each of the support protrusion may be in contact with and supported on the guide part of the opposite separator.

The plurality of support protrusions may be arranged to be spaced apart from each other along a direction intersecting a flow direction of the cooling medium flowing through the guide part.

The plurality of support protrusions may be arranged along a direction intersecting a flow direction of the cooling medium in the guide part to be spaced apart from each other, thus forming one layer, and a plurality of layers may be arranged along the flow direction of the cooling medium to be spaced apart from each other.

Cooling medium flow fields formed in adjacent layers may be arranged to be aligned along the direction in which the cooling medium flows.

The adhesive medium may have a shape of a line formed in a direction intersecting the flow direction of the cooling medium.

The plurality of support protrusions may be arranged along a direction intersecting the flow direction of the cooling medium in the guide part to be spaced apart from each other, thus forming a layer, and the adhesive medium may have a shape of a line formed in a direction intersecting the flow direction of the cooling medium at a point spaced apart from the layer that is formed by the support protrusions.

The plurality of support protrusions may be arranged along a direction intersecting the flow direction of the cooling medium in the guide part to be spaced apart from each other, thus forming one layer, the plurality of layers may be arranged along the flow direction of the cooling medium to be spaced apart from each other, and the adhesive medium may have a shape of a line formed in a direction intersecting the flow direction of the cooling medium between the plurality of layers.

The plurality of support protrusions may be arranged to be offset from each other along a direction intersecting the flow direction of the cooling medium in the guide part, thus forming a zigzag-shaped layer, and the adhesive medium may have a shape of a line formed along the direction intersecting the flow direction of the cooling medium in a zigzag shape to avoid the support protrusions.

Each of the separators may be made of a metal material, and the support protrusions may be formed and molded so that points of the guide part protrude toward the cooling surface.

According to the present disclosure, a unitized fuel cell has excellent sealing of a cooling medium, is easy to secure a flow field for the cooling medium, and has excellent cooling efficiency due to the low deformation of the flow field, thereby effectively preventing the fuel cell from deteriorating.

### BRIEF DESCRIPTION OF THE DRAWINGS

The above and other features and advantages of embodiments of the present disclosure can be more clearly understood from the following detailed description taken in conjunction with the accompanying drawings, in which:

FIG. 1 is an exploded perspective view illustrating a unitized fuel cell according to an embodiment of the present disclosure;

FIGS. 2 and 3 are views illustrating a guide part of a separator of the unitized fuel cell according to an embodiment of the present disclosure;

FIG. 4 is a sectional view taken along line A-A′ of FIG. 3 illustrating the unitized fuel cell according to an embodiment of the present disclosure;

FIG. 5 is a sectional view taken along line B-B′ of FIG. 3 illustrating the unitized fuel cell according to an embodiment of the present disclosure;

FIG. 6 is a sectional view taken along line C-C′ of FIG. 3 illustrating the unitized fuel cell according to an embodiment of the present disclosure;

FIG. 7 is a sectional view taken along line D-D′ of FIG. 3 illustrating the unitized fuel cell according to an embodiment of the present disclosure;

FIGS. 8 and 9 are sectional views illustrating a unitized fuel cell according to embodiments of the present disclosure; and

FIG. 10 is a view corresponding to FIG. 3 to illustrate an adhesive medium of the unitized fuel cell according to an embodiment of the present disclosure.

### DETAILED DESCRIPTION OF ILLUSTRATIVE EMBODIMENTS

Hereafter, embodiments of the present disclosure will be described in detail with reference to the accompanying drawings and same or similar components can be given the same reference numerals regardless of the number of figures and are not necessarily repeatedly described.

In the following description, if it is decided that the detailed description of known technologies related to the present disclosure makes the subject matter of the embodiments described herein unclear, the detailed description can be omitted. Further, the accompanying drawings are provided for ease of understanding embodiments disclosed in the specification, and the technical spirit disclosed in the specification is not necessarily limited by the accompanying drawings, and all changes, equivalents, and replacements can be understood as being included in the spirit and scope of the present disclosure.

Terms including ordinal numbers such as “first”, “second”, etc. may be used to describe various components, but the components are not necessarily construed as being limited to the terms. The terms can be used to distinguish one component from another component, for example.

Singular forms can include plural forms unless the context clearly indicates otherwise.

It can be further understood that the terms “comprise” or “have” used in this specification, can specify the presence of stated features, steps, operations, components, parts, or a combination thereof, but do not preclude the presence or addition of one or more other features, numerals, steps, operations, components, parts, or a combination thereof.

It can be understood that when one element is referred to as being “connected to” or “coupled to” another element, it may be connected directly to or coupled directly to another element or be connected to or coupled to another element, having other element(s) intervening therebetween. On the other hand, it can be understood that when one element is referred to as being “connected directly to” or “coupled directly to” another element, it may be connected to or coupled to another element without the other element intervening therebetween.

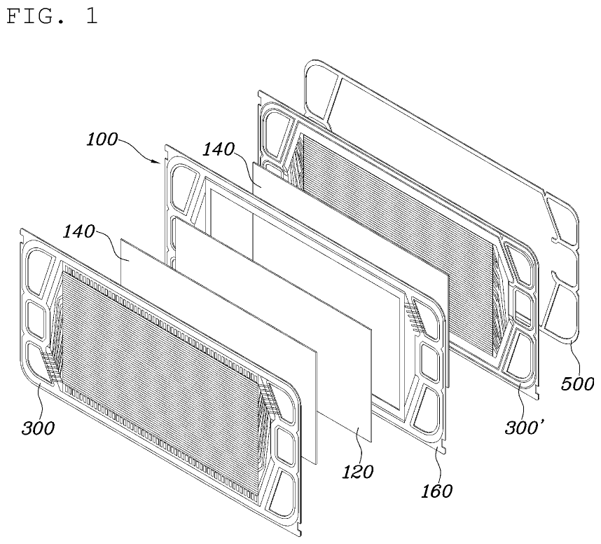

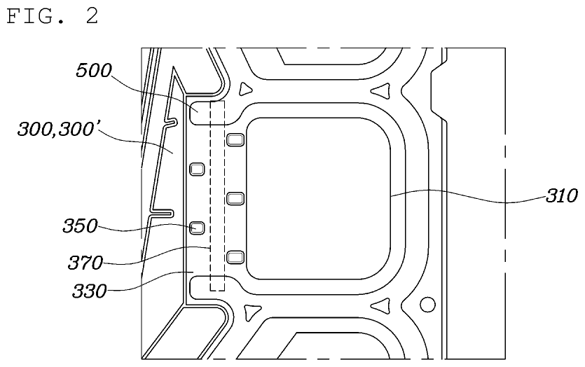

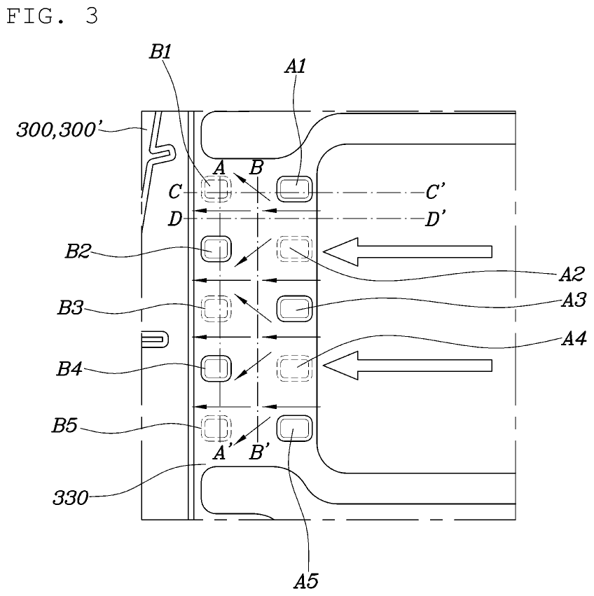

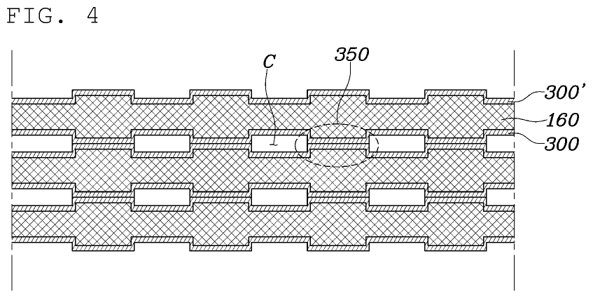

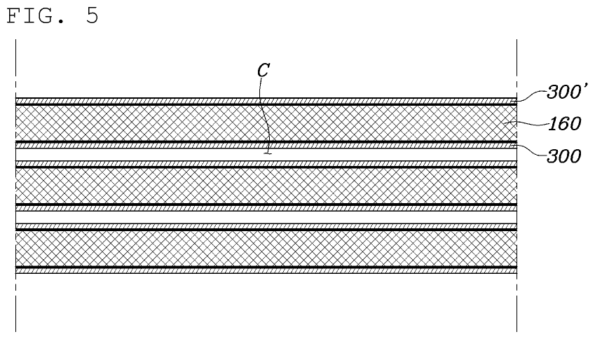

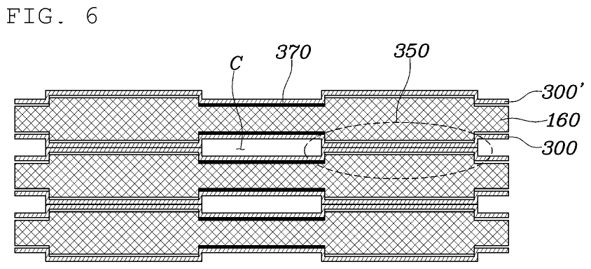

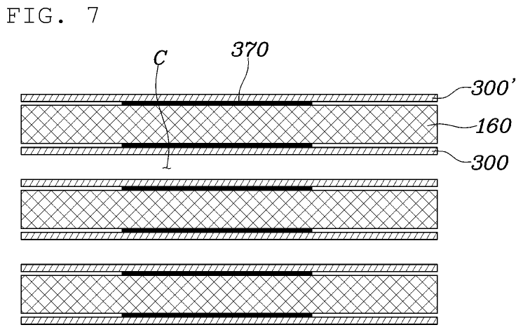

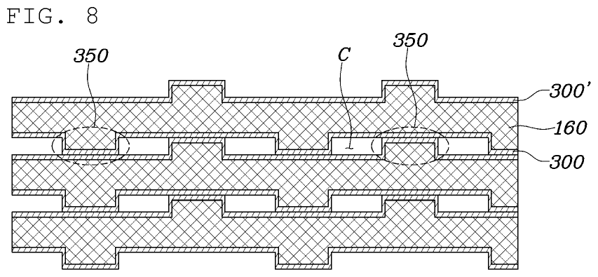

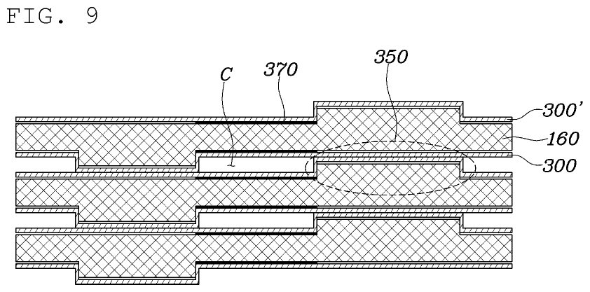

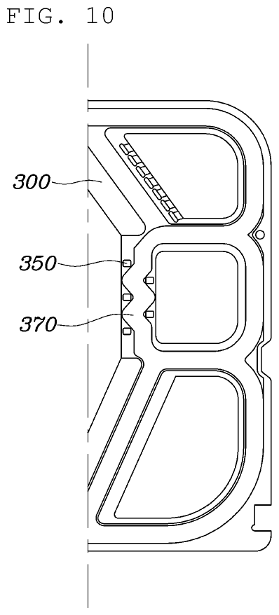

FIG. 1 is an exploded perspective view illustrating a unitized fuel cell according to an embodiment of the present disclosure. FIGS. 2 and 3 are views illustrating a guide part of a separator of the unitized fuel cell according to an embodiment of the present disclosure. FIG. 4 is a sectional view taken along line A-A′ of FIG. 3 illustrating the unitized fuel cell according to an embodiment of the present disclosure shown in FIG. 3. FIG. 5 is a sectional view taken along line B-B′ of FIG. 3 illustrating the unitized fuel cell according to an embodiment of the present disclosure shown in FIG. 3. FIG. 6 is a sectional view taken along line C-C′ of FIG. 3 illustrating the unitized fuel cell according to an embodiment of the present disclosure shown in FIG. 3. FIG. 7 is a sectional view taken along line D-D′ of FIG. 3 illustrating the unitized fuel cell according to an embodiment of the present disclosure shown in FIG. 3. FIGS. 8 and 9 are sectional views illustrating a unitized fuel cell according to another embodiment of the present disclosure. FIG. 10 is a view corresponding to FIG. 3 to illustrate an adhesive medium of the unitized fuel cell according to another embodiment of the present disclosure.

The unitized fuel cell according to an embodiment of the present disclosure includes a cell frame 100 to which an Electricity Generating Assembly (EGA) and a frame 160 are coupled, a plurality of separators 300 and 300′ that are stacked on both sides of the cell frame 100, respectively, include on one side thereof a reaction surface to face the cell frame 100, include on the other side a cooling surface through which a cooling medium flows, include on an end thereof a manifold hole 310 through which the cooling medium flows, and include a cooling medium guide part 330 extending from the manifold hole 310 and having a predetermined or selected area, a plurality of support protrusions 350 that protrude from the guide part 330 of each of the separators 300 and 300′ toward the cooling surface, are spaced apart from each other, and include a cooling medium flow field C formed between the spaced protrusions, and an adhesive medium 370 that is located between the cell frame 100 and the reaction surface on the guide part 330 of each of the separators 300 and 300′ to provide a coupling force to each of the separators 300 and 300′ and the cell frame 100, and is provided at a point that does not overlap the plurality of support protrusions 350 on the guide part 330.

FIG. 1 is an exploded perspective view illustrating a unitized fuel cell according to an embodiment of the present disclosure. The fuel cell of the present disclosure can be configured such that the EGA and the frame 160 are integrated to form the cell frame 100. The EGA can be configured such that an electrolyte membrane and an electrode are coupled to form a MEA 120. The EGA can be formed by coupling gas diffusion layers (GDL) 140 to both sides of the MEA 120.

The frame 160 can be used to support the EGA. The frame 160 may be made of various materials, and may be typically formed of a plastic material through injection molding, for example. The frame 160 may be formed of engineering plastic or super engineering plastic with the thermal expansion coefficient of 40×10⁻⁶/° C. or less through injection molding, and may be formed in a three-dimensional structure through injection molding, injection/compression hybrid molding, compression molding, or 3D printing, for example.

The EGA may be attached to the frame 160 using adhesive or the like. Further, the frame 160 may be injection molded with the EGA inserted. Through these methods, the EGA and the frame 160 may be integrated into the cell frame 100.

The cell frame 100 can be located between the separators 300 and 300′. The separators 300 and 300′ may be composed of an anode separator and a cathode separator. Air can be introduced and flow between the anode separator and the EGA, and hydrogen can be supplied and flow between the cathode separator and the EGA.

The side of each of the separators 300 and 300′ facing the EGA can form a reaction surface, while the opposite side can form a cooling surface. A gasket 500 can be coupled to the cooling surface of either the anode separator or the cathode separator to seal the cooling medium. In an embodiment, after the EGA and the frame 160 are coupled to form the cell frame 100, the separators 300 and 300′ can be attached to both sides of the cell frame 100, respectively, and the gasket 500 can be coupled to the separator 300 or 300′ to form one unit fuel cell. This may be defined as the unitized fuel cell.

The EGA may be configured by coupling an electrolyte membrane, an electrode, and a gas diffusion layer. The frame 160 may be formed of a plastic material. The EGA and the frame 160 may be integrally coupled to form the cell frame 100. Further, the cell frame 100 and each of the separators 300 and 300′ may be integrally coupled through the adhesive medium 370, so one pair of separators 300 and 300′ and the cell frame 100 between the pair of separators 300 and 300′ may form one unitized unit fuel cell.

Further, one fuel cell and another adjacent fuel cell may be stacked so that the cooling surfaces of the separators 300 and 300′ face each other, and the gasket 500 may be located between the facing separators 300 and 300′ to seal the cooling medium.

In the case of the unitized fuel cell, one unit cell may be independently manufactured and conveyed, each cell may be coupled in a stacked manner and then be separated into cell units, thus facilitating removal, maintenance, and recycling.

When the fuel cells are stacked, the gasket 500 may be provided between the anode separator and the cathode separator, and the cooling medium may be introduced and flow between the facing cooling surfaces to cool the fuel cell. In the case of the cooling medium, various media such as coolant or special refrigerants may be applied.

FIGS. 2 and 3 are views illustrating a guide part of the separator of the unitized fuel cell according to an embodiment of the present disclosure.

The cooling medium can perform cooling while flowing between the cooling surfaces of the facing separators 300 and 300′. Manifold holes 310 for introducing and discharging the cooling medium can be formed at both ends of the separator 300 or 300′. The manifold holes can be formed to introduce and circulate the cooling medium as well as air and hydrogen. Therefore, three manifold holes may be formed at each end of the separator. The manifold hole described in an embodiment of the present disclosure can refer to a hole through which the cooling medium flows. FIG. 2 shows the manifold hole 310 through which the cooling medium can be introduced/discharged. The gasket 500 can be placed to surround the periphery of the manifold hole 310, thus sealing the cooling medium.

Further, the cooling medium introduced from the manifold hole 310 can be guided to the cooling surface of the separator 300 or 300′. The guide part 330 can be provided on the separator 300 or 300′ to extend from the manifold hole 310 to the cooling surface. The guide part 330 can be in the form of a flat plate, and can define a specific flow field. In an embodiment, while the cooling medium flows between the guide parts 330 facing each other on the cooling surfaces of the separators 300 and 300′, the cooling medium can be guided to the cooling surfaces of the separators 300 and 300′.

Therefore, in the case of the facing guide parts 330, the sectional area of the flow field can be maintained by maintaining a constant distance therebetween. In an embodiment, this can keep the cooling efficiency of the fuel cell constant, can prevent deterioration due to the local overheating of the fuel cell by reducing the cooling deviation between cells, and can realize the thermal balancing between the cells.

According to an embodiment of the present disclosure, the support protrusions 350 can be formed on the guide parts 330 to support a flow field space between the guide parts 330 of the separators 300 and 300′. The separators 300 and 300′ may be made using various materials and methods. According to an embodiment of the present disclosure, the separator can be formed of a metal material in view of support strength, thermal conductivity, formability, etc. Therefore, the separators 300 and 300′ may be made of the metal material, and the support protrusions 350 may be formed and molded so that some points of the guide part 330 protrude toward the cooling surface.

The support protrusions 350 can protrude from the guide parts of the separators 300 and 300′ to the cooling surfaces, can be composed of a plurality of protrusions spaced apart from each other, and can form a cooling medium flow field at points between the spaced support protrusions. FIG. 3 is a diagram illustrating a completed thermocouple unit cell of an embodiment when seen from one side. The separator that is visible in the drawing of FIG. 3 and the separator that is placed behind the former and is invisible in the drawing of FIG. 3 face each other with the guide parts spaced apart from each other. In the facing guide parts, the support protrusions can protrude toward the cooling space.

An embodiment of the present disclosure corresponds to a case where the support protrusions 350 protrude from each guide part 330 by half of the height of the entire cooling flow field. One fuel cell and another adjacent fuel cell may be stacked so that the cooling surfaces of the separators face each other, and the two separators 300 and 300′ may be mutually supported through the support protrusions 350 in the guide parts 330.

In the two separators 300 and 300′ facing the cooling surfaces according to an embodiment of the present disclosure, the support protrusions 350 can be formed at corresponding points in the guide parts 330, so the support protrusions 350 of the two separators 300 and 300′ can be supported while contacting each other at ends thereof. The molding depth of the support protrusion 350 might not be deep, so the formability of the separators 300 and 300′ can be increased, and the support protrusion 350 can easily obtain a required strength.

FIG. 4 is a sectional view taken along line A-A′ of FIG. 3 illustrating the unitized fuel cell according to an embodiment of the present disclosure shown in FIG. 3. As shown in the drawing, the support protrusions 350 can be arranged in a direction intersecting a direction in which the cooling medium flows, and can be spaced apart from each other at regular intervals. Further, the facing support protrusions 350 can be formed to protrude toward each other at the same position, so the ends of the facing support protrusions 350 come into contact with each other to be supported inside the cooling flow field. A cooling flow field C can be formed between the support protrusions 350 to allow the cooling medium to flow therethrough. Therefore, the support protrusions 350 can support the guide parts 330, and can serve to maintain the sectional area and to form the cooling flow field C, simultaneously.

FIG. 5 is a sectional view taken along line B-B′ of FIG. 3 illustrating the unitized fuel cell according to an embodiment of the present disclosure shown in FIG. 3. It can be seen that a point where the support protrusion 350 is not located can form a predetermined or selected flow field C having a predetermined or selected sectional area. The support protrusion 350 can serve to support the flow field C so that the depth thereof is kept constant.

FIG. 6 is a sectional view taken along line C-C′ of FIG. 3 illustrating the unitized fuel cell according to an embodiment of the present disclosure shown in FIG. 3. FIG. 6 shows a state in which the unitized fuel cell is cut along a direction in which the cooling medium flows. The support protrusions 350 can be arranged at regular intervals. FIG. 7 is a sectional view taken along line D-D′ of FIG. 3 illustrating the unitized fuel cell according to an embodiment of the present disclosure shown in FIG. 3. FIG. 7 shows an embodiment without support protrusions and the flow field C is formed to be maintained in a straight line along the flow of the cooling medium.

As shown in the drawings, the plurality of support protrusions 350 may be arranged to be spaced apart from each other along the direction intersecting the flow direction of the cooling medium flowing through the guide part 330. As illustrated in FIG. 4, the plurality of support protrusions 350 may be arranged along the direction intersecting the flow direction of the cooling medium in the guide part 330 to be spaced apart from each other, thus forming one layer, and a plurality of layers may be arranged along the flow direction of the cooling medium to be spaced apart from each other. In the illustrated embodiment, it is shown that the support protrusions can form two layers. As shown in FIG. 3, it can be seen that the layer close to the manifold hole can be formed through the support protrusions A1 to A5, and another layer spaced apart therefrom is formed through the support protrusions B1 to B5.

Further, the cooling medium flow fields C formed in adjacent layers may be arranged to be aligned along the direction in which the cooling medium flows. Therefore, even if the plurality of layers are formed, the flow fields C formed between the support protrusions 350 can be aligned in a row, thus allowing the cooling medium to stably flow.

On the other hand, the separators 300 and 300′ can be attached to the cell frame 100 through the adhesive medium 370, thus forming one unit fuel cell. Particularly, the adhesive medium 370 can be disposed between the reaction surface in the guide part 330 of the separator 300 or 300′ and the cell frame 100 to provide a coupling force to the separator 300 or 300′ and the cell frame 100, thus achieving the sealing of the cooling medium.

Further, the adhesive medium 370 can be provided at a point on the guide part 330 that do not overlap the plurality of support protrusions 350. Because the separators 300 and 300′ can be panel-shaped metal, a protruding shape can appear on the cooling surface of the separator 300 or 300′ and a recessed shape can appear on the reaction surface when the support protrusions 350 are molded by pressing or the like. Therefore, to exhibit the attachment performance of the adhesive medium 370, the adhesive medium 370 can be applied to a point on the reaction surface of the separator 300 or 300′ that avoids the support protrusion 350 formed in a groove shape, so actual adhesion can be continuously achieved without interruption.

Therefore, the adhesive medium 370 can be provided at a point on the guide part 330 that does not overlap the plurality of support protrusions 350.

The adhesive medium 370 may have the shape of a line formed in a direction intersecting the flow direction of the cooling medium. Through such a shape, sealing may be maintained, and the adhesive medium 370 may be formed in a continuous line shape without interruption.

To be more specific, the plurality of support protrusions 350 can be arranged along the direction intersecting the flow direction of the cooling medium in the guide part 330 to be spaced apart from each other, thus forming a layer, and the adhesive medium 370 may have the shape of a line formed in a direction intersecting the flow direction of the cooling medium at a point spaced apart from the layer that is formed by the support protrusions 350.

Particularly, when the support protrusions 350 forms two layers as in the embodiment of the present disclosure, the two layers can be spaced apart from each other and the adhesive medium 370 can be located at a point between the spaced layers as shown in FIG. 2. In this case, the adhesive medium 370 may form a predetermine line without interruption regardless of the shape of the groove in the reaction surface of the separator 300 or 300′ due to the support protrusions 350. FIG. 10 shows a state where the adhesive medium 370 forms a predetermined line.

The plurality of support protrusions 350 may be arranged along the direction intersecting the flow direction of the cooling medium in the guide part 330 to be spaced apart from each other, thus forming one layer, and the plurality of layers may be arranged along the flow direction of the cooling medium to be spaced apart from each other. The adhesive medium 370 may have the shape of a line formed in a direction intersecting the flow direction of the cooling medium between the plurality of layers.

FIGS. 8 and 9 are sectional views illustrating a unitized fuel cell according to another embodiment of the present disclosure. FIG. 8 corresponds to FIG. 4 taken along line A-A′ of the fuel cell in FIG. 3. FIG. 9 corresponds to the cutaway view of FIG. 6 taken along line C-C′.

The two separators 300 and 300′ facing the cooling surfaces can be formed such that the support protrusions 350 are offset from each other in the guide parts 330, and thereby the end of the support protrusion 350 can be in contact with and supported on the guide part 330 of the opposite separator. Instead of protruding each of the support protrusions 350 in half such that the support protrusions meet each other on the inside, one support protrusion 350 can protrude high up to the opposing guide part 330, and the end thereof can be supported on the opposing guide part 330.

For this shape, the support protrusions 350 of the separators 300 and 300′ facing each other can be formed at offset points rather than at corresponding points. Even in this case, the overall configuration of the layer through the support protrusions 350 can be the same, but also there can be no substantial difference in the configuration of the flow field except for only the height of each support protrusion 350. Likewise, the adhesive medium 370 can be applied along the point where the support protrusion 350 is not formed.

However, in each of the separators 300 and 300′, the support protrusions 350 may be arranged in a zigzag shape as shown in FIG. 10. That is, based on FIG. 3, support protrusions A1, A3, A5, B2, and B4 can be formed on the guide part of one separator, while support protrusions A2, A4, B1, B3, and B5 can be formed on the guide part of the other separator. Thus, the support protrusions may be arranged on the separators 300 and 300′, as shown in FIG. 10.

FIG. 10 is a view corresponding to FIG. 3 to illustrate an adhesive medium of the unitized fuel cell according to another embodiment of the present disclosure. In this case, the plurality of support protrusions 350 may be arranged to be offset from each other along the direction intersecting the flow direction of the cooling medium in the guide parts 330, thus forming a zigzag-shaped layer, and the adhesive medium 370 may have the shape of a line formed along the direction intersecting the flow direction of the cooling medium in a zigzag shape to avoid the support protrusions 350.

The adhesive medium 370 may be applied in a zigzag shape between the support protrusions 350, so a straight-line distance between the layers of the support protrusions 350 may be designed to be shorter. Even if a gap between the layers is reduced as such, the line width of the required adhesive medium 370 may be maintained. Consequently, in an embodiment, it is possible to reduce the entire area of the guide part 330 while maintaining an adhesive force, and to increase the reaction area of the fuel cell.

As described above, an embodiment of the present disclosure can provide a unitized fuel cell that has excellent sealing of a cooling medium, is easy to secure a flow field for the cooling medium, and has excellent cooling efficiency due to the low deformation of the flow field, thereby effectively preventing the fuel cell from deteriorating.

Although the present disclosure was provided above in relation to specific embodiments shown in the drawings, it can be apparent to those skilled in the art that embodiments of the present disclosure may be changed and modified in various ways without departing from the scope of the present disclosure, which is described in the following claims.

What is claimed is:

1. A unitized fuel cell, comprising:
a cell frame coupled to an electricity generating assembly (EGA) and a frame;
a plurality of separators stacked on both sides of the cell frame, respectively, each separator comprising a reaction surface on a first side facing the cell frame, a cooling surface on a second side configured to flow cooling medium therethrough, a manifold hole on an end configured to flow cooling medium therethrough, and a cooling medium guide part extending from the manifold hole and having a guide part area;
a plurality of support protrusions protruding from the guide part of each of the separators toward the cooling surface, spaced apart from each other, and including a cooling medium flow field between the spaced protrusions; and
an adhesive medium disposed between the cell frame and the reaction surface on the guide part of each of the separators to provide a coupling force to each of the separators and the cell frame, such that the adhesive medium does not overlap the plurality of support protrusions on the guide part.

2. The cell of claim 1, wherein the EGA comprises an electrolyte membrane, an electrode, and a gas diffusion layer, the electrolyte membrane, the electrode, and the gas diffusion layer being coupled together,
wherein the frame comprises a plastic material, and
wherein the EGA and the frame are integrally coupled to form the cell frame.

3. The cell of claim 1, wherein the cell frame and each of the separators are integrally coupled using the adhesive medium.

4. The cell of claim 1, wherein the plurality of support protrusions are arranged to be spaced apart from each other along a direction intersecting a flow direction of cooling medium through the guide part.

5. The cell of claim 1, wherein the plurality of support protrusions are arranged along a direction intersecting a flow direction of cooling medium through the guide part, the plurality of support protrusions being spaced apart from each other to form a layer, and a plurality of the layers are arranged along the flow direction of cooling medium and spaced apart from each other.

6. The cell of claim 5, wherein cooling medium flow fields formed in adjacent layers are arranged to be aligned along the direction in which cooling medium flows.

7. The cell of claim 1, wherein the adhesive medium has a shape of a line formed in a direction intersecting the flow direction of cooling medium.

8. The cell of claim 1, wherein the plurality of support protrusions are arranged along a direction intersecting the flow direction of cooling medium through the guide part, the plurality of support protrusions being spaced apart from each other to form a layer, and the adhesive medium having a shape of a line formed in a direction intersecting the flow direction of cooling medium at a point spaced apart from the layer.

9. The cell of claim 1, wherein the plurality of support protrusions are arranged along a direction intersecting the flow direction of cooling medium through the guide part, the plurality of support protrusions being spaced apart from each other to form a plurality of layers, the plurality of layers being arranged along the flow direction of cooling medium and spaced apart from each other, and the adhesive medium having a shape of a line formed in a direction intersecting the flow direction of cooling medium between the plurality of layers.

10. The cell of claim 1, wherein the plurality of support protrusions are arranged to be offset from each other along a direction intersecting the flow direction of cooling medium through the guide part forming a zigzag-shaped layer, and the adhesive medium having a shape of a line formed along the direction intersecting the flow direction of cooling medium in a zigzag shape to avoid the support protrusions.

11. The cell of claim 1, wherein each of the separators is made of a metal material, and the support protrusions are formed and molded so that points of the guide part protrude toward the cooling surface.

12. A fuel cell apparatus comprising:
a first unitized fuel cell;
a second unitized fuel cell, wherein each of the unitized fuel cells comprises:
a cell frame coupled to an Electricity Generating Assembly (EGA) and a frame,
a plurality of separators stacked on both sides of the cell frame, respectively, each separator comprising a reaction surface on a first side facing the cell frame, a cooling surface on a second side configured to flow cooling medium therethrough, a manifold hole on an end configured to flow cooling medium therethrough, and a cooling medium guide part extending from the manifold hole and having a guide part area,
a plurality of support protrusions protruding from the guide part of each of the separators toward the cooling surface, spaced apart from each other, and including a cooling medium flow field between the spaced protrusions, and
an adhesive medium disposed between the cell frame and the reaction surface on the guide part of each of the separators to provide a coupling force to each of the separators and the cell frame,
wherein the cell frame and each of the separators are integrally coupled using the adhesive medium,
wherein the first unitized fuel cell is stacked on the second unitized fuel cell, wherein the cooling surfaces of the separators of the first and second unitized fuel cells face of each other; and
a gasket is disposed between the facing separators to form a cooling medium seal.

13. The apparatus of claim 12, wherein the adhesive medium does not overlap the plurality of support protrusions on the guide part.

14. A fuel cell apparatus comprising:
a first unitized fuel cell; and
a second unitized fuel cell, wherein each of the unitized fuel cells comprises:
a cell frame coupled to an Electricity Generating Assembly (EGA) and a frame,
a plurality of separators stacked on both sides of the cell frame, respectively, each separator comprising a reaction surface on a first side facing the cell frame, a cooling surface on a second side configured to flow cooling medium therethrough, a manifold hole on an end configured to flow cooling medium therethrough, and a cooling medium guide part extending from the manifold hole and having a guide part area,
a plurality of support protrusions protruding from the guide part of each of the separators toward the cooling surface, spaced apart from each other, and including a cooling medium flow field between the spaced protrusions, and
an adhesive medium disposed between the cell frame and the reaction surface on the guide part of each of the separators to provide a coupling force to each of the separators and the cell frame, such that the adhesive medium does not overlap the plurality of support protrusions on the guide part,
wherein the cell frame and each of the separators are integrally coupled using the adhesive medium,
wherein the first unitized fuel cell is adjacent the second unitized fuel cell, and
wherein the first and second unitized fuel cells are stacked so that the cooling surfaces of the separators face each other, and the separators are mutually supported through the support protrusions in the guide parts.

15. The apparatus of claim 14, wherein the adhesive medium does not overlap the plurality of support protrusions on the guide part.

16. The apparatus of claim 14, wherein the separators facing the cooling surfaces are formed such that the support protrusions are formed at corresponding points in the guide parts, and thereby the support protrusions of the separators are supported while contacting each other at ends thereof.

17. The apparatus of claim 14, wherein the separators facing the cooling surfaces are formed such that the support protrusions are offset from each other in the guide parts, and thereby an end of each of the support protrusion is in contact with and supported on the guide part of the opposite separator.
